(19) United States
(12) Patent Application Publication
(10) Pub. No.: US 2013/0126468 A1
(43) Pub. Date: May 23, 2013

(54) METHOD FOR MANUFACTURING NANO WIRE GRID POLARIZER

(71) Applicant: ELECTRONICS AND TELECOMMUNICATIONS, Daejeon (KR)

(72) Inventors: DONG-PYO KIM, Daejeon (KR); Kyu-Ha BAEK, Daejeon (KR)

(73) Assignee: ELECTRONICS AND TELECOMMUNICATIONS RESEARCH INSTITUTE, Daejeon (KR)

(21) Appl. No.: 13/658,127

(22) Filed: Oct. 23, 2012

(30) Foreign Application Priority Data
Nov. 23, 2011 (KR) 10-2011-0123088

(51) Int. Cl. G02B 1/12; B29D 11/00

(52) U.S. Cl. 216/24; 427/163.1; 977/887

(57) ABSTRACT

Disclosed is a method for manufacturing a nano wire grid polarizer, including: applying a curable resin on a glass substrate, and then forming a nano pattern by pressurizing the curable resin with a nano imprint mold; processing a surface of the nano pattern in which an upper part of the nano pattern is hydrophobicized and an inside of the nano pattern is hydrophilicized; filling the inside of the nano pattern with nano metal particles; and forming a nano wire grid polarizer by removing the nano pattern.

### CROSS-REFERENCE TO RELATED APPLICATIONS

This application is based on and claims priority from Korean Patent Application No, 10-2011-0123088, filed on Nov. 23, 2011, with the Korean Intellectual Property Office, the disclosure of which is incorporated herein in its entirety by reference.

### TECHNICAL FIELD

The present disclosure relates to a polarizer which selectively transmits light emitted from a backlight of a liquid crystal display in a specific direction, and more particularly to a method for manufacturing a nano wire grid polarizer with a simple manufacturing process and excellent productivity.

### BACKGROUND

A polarizer currently and mainly used includes a polarizer using an absorption-type polarizing film and a nano wire grid polarizer. A polarizer using the absorption-type polarizing film transmits only 50% of incident rays. On the other hand, the nano wire grid polarizer transmits light vertical to an axis of the nano wire grid polarizer among incident rays and reflects light horizontal to the axis of the nano wire grid polarizer, and improves light transmittance by repeating the processes of the transmission and the reflection. In this case, a pitch of a nano pattern of the nano wire polarizer is ½ of a wavelength of incident visible rays. Accordingly, the wavelength of the visible rays is in a range of 400 to 700 nm, so that the pitch of the nano pattern is equal to or less than 200 nm.

In the meantime, a method for manufacturing a nano wire grid polarizer in the related art requires an etching process of two times. Particularly, a metal thin film is deposited on a glass substrate, a nano pattern is formed by using a photosensitive film, and a nano pattern is formed on the metal thin film by a dry etching process. Then, the metal thin film is etched by using the nano pattern, and then the nano wire grid polarizer is manufactured by removing the nano pattern.

However, in the method for manufacturing the nano wire grid polarizer in the related art, if a process variable is not precisely controlled in the etching process of the nano pattern, etching uniformity is deteriorated, so that it is impossible to form the nano pattern having a regular size and obtain an excellent polarizer. In order to solve the problem, a method for forming a nano wire grid polarizer by using a nano metal paste and a spin coating method has been suggested. However, such a method needs a large amount of nano metal pastes and is difficult to be applied to a large area.

### SUMMARY

The present disclosure has been made in an effort to provide a method for manufacturing a nano wire grid polarizer with a simple manufacturing process and excellent productivity.

An exemplary embodiment of the present disclosure provides a method for manufacturing a nano wire grid polarizer, including: applying a curable resin on a glass substrate, and then forming a nano pattern by pressurizing the curable resin with a nano imprint mold; processing a surface of the nano pattern in which an upper part of the nano pattern is hydrophobicized and an inside of the nano pattern is hydrophilicized; filling the inside of the nano pattern with nano metal particles; and forming a nano wire grid polarizer by removing the nano pattern.

According to the exemplary embodiments of the present disclosure, by providing the method for manufacturing the nano wire grid polarizer in which the nano pattern is formed by using the nano imprint mold, it is possible to manufacture a nano pattern with low expenses and high mass-productivity.

By providing the method for manufacturing the nano wire grid polarizer, in which the surface of the nano pattern is hydrophilicized and hydrophobicized, and the nano metal paste or the nano metal ink is self-aligned between the nano patterns, so that the nano metal particles are filled, it is possible to simplify a manufacturing process, reduce manufacturing costs, and manufacture a nano wire grid polarizer having excellent productivity.

The foregoing summary is illustrative only and is not intended to be in any way limiting. In addition to the illustrative aspects, embodiments, and features described above, further aspects, embodiments and features will become apparent by reference to the drawings and the following detailed description.

### BRIEF DESCRIPTION OF THE DRAWINGS

FIGS. 1 to 5 are flowcharts illustrating a method for manufacturing a nano wire grid polarizer according to an exemplary embodiment of the present disclosure.

### DETAILED DESCRIPTION

In the following detailed description, reference is made to the accompanying drawing, which form a part hereof. The illustrative embodiments described in the detailed description, drawing, and claims are not meant to be limiting. Other embodiments may be utilized, and other changes may be made, without departing from the spirit or scope of the subject matter presented here.

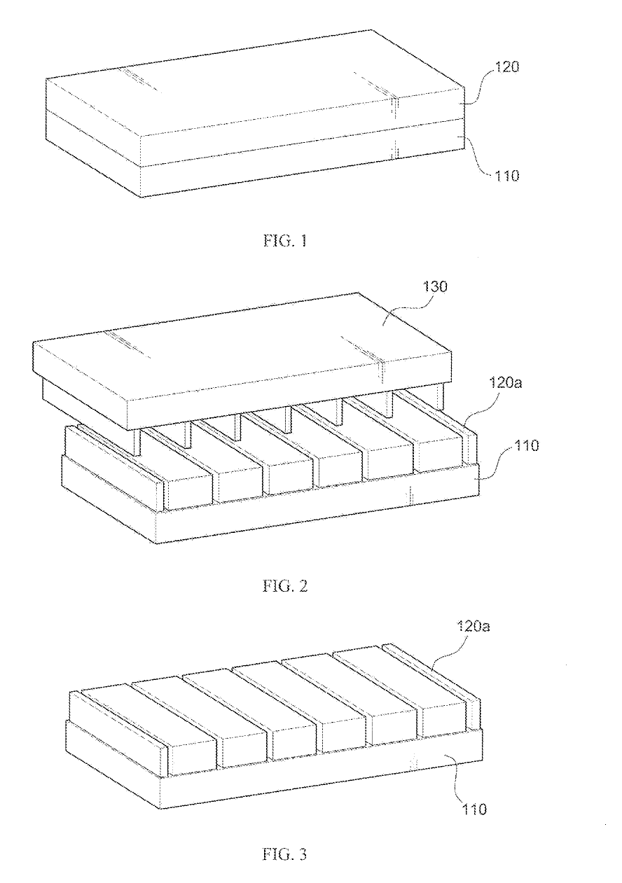

FIGS. 1 to 5 are flowcharts illustrating a method for manufacturing a nano wire grid polarizer according to an exemplary embodiment of the present disclosure.

Referring to FIG. 1, a curable resin 120 is applied on a glass substrate 110. Here, the curable resin 120 may be a UV resin or a thermosetting resin.

Referring to FIG. 2, a nano imprint mold 130 is pressurized onto the curable resin 120 to form a nano pattern 120a. In this case, in order to achieve the easy demold from the curable resin 120, a release agent may be processed on a surface of the nano imprint mold 130 or the nano imprint mold 130 having a releasing property may he used.

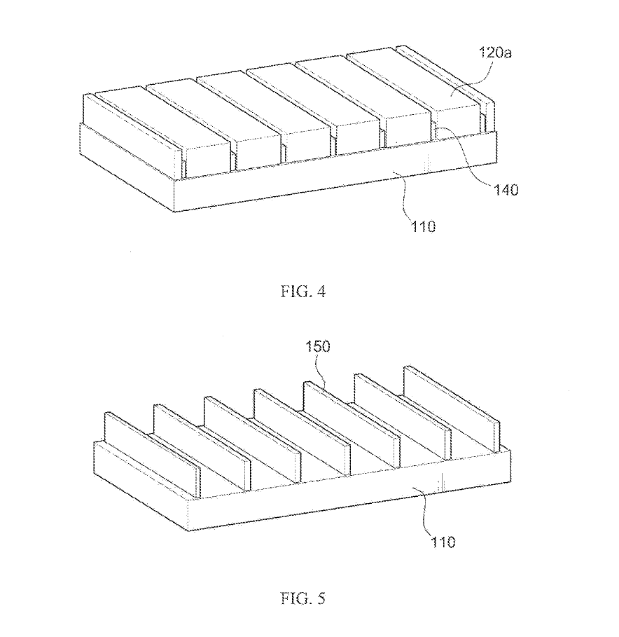

Referring to FIG. 3, an upper part of the nano pattern 120a is hydrophobicized and an inside of the nano pattern 120a is hydrophilicized. In this case, a hydrophobic resin film is positioned on the nano pattern 120a and the hydrophobic resin film is heat-treated, so that the upper part of the nano pattern 120a is hydrophobicized.

When the resin having the hydrophobicity is used instead of the curable resin 120, a process of hydrophobicizing the nano pattern 120a is not required.

Referring to FIG. 4, nano metal particles 140 are filled inside the nano pattern 120a, in this case, a process of printing the nano metal particles 140 in the nano pattern. 120a. in a vacuum state, and pressurizing the nano metal particles 140 is repeated several times, so as to fill the nano metal particles 140 up to a height of the nano pattern 120a. Here, the nano metal particle 140 is a form of a nano metal paste or a nano metal ink, and for example, may use metal including Ag, Al, Cu, Ti and W, or a carbon-based paste including graphene.

Then, the nano metal particles 140 are heat-treated at a pressure and a temperature (for example, 200° C. or lower) under a condition of sublimation of the nano metal particles 140 by using a vacuum oven, a hot plate, or a pressing oven, so that bubble left inside the nano pattern 120a may be removed.

Referring to FIG. 5, after the nano metal particles 140 are tilled inside the nano pattern 120a, the nano pattern 120a is removed from the glass substrate 110, to form a nano w re grid polarizer 150. Here, the nano pattern 120a is removed from the glass substrate 110 by an oxygen plasma process or a wet process.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A method for manufacturing a nano wire grid polarizer, comprising:
applying a curable resin on a glass substrate, and then forming a nano pattern by pressurizing the curable resin with a nano imprint mold;
processing a surface of the nano pattern in which an upper part of the nano pattern is hydrophobicized and an inside of the nano pattern is hydrophilicized;
filling the inside of the nano pattern with nano metal particles; and
forming a nano wire grid polarizer by removing the nano pattern.

2. The method of claim 1, further comprising:
processing a release agent on a surface of the nano imprint mold before the forming of the nano pattern.

3. The method of claim 1, wherein the curable resin is a UV resin or a thermosetting resin.

4. The method of claim 1, Wherein in the processing of the surface of the nano pattern, a hydrophobic resin film is positioned on the nano pattern and the hydrophobic resin film is heat-treated, so that the upper part of the nano pattern is hydrophobicized.

5. The method of claim 1, wherein the nano metal particle is in a form of a nano metal paste or a nano metal ink.

6. The method of claim 1, wherein the nano metal. particle is metal including at least one of Ag, Al, Cu, Ti and W, or a carbon-based paste including graphene.

7. The method of claim 1, wherein in the filling of the nano metal particles, the nano metal particles are filled inside the nano pattern by repeating a process of printing the nano metal particles in the nano pattern in a vacuum state, and pressurizing the printed nano metal particles.

8. The method of claim 1, further comprising:
heat-treating the nano metal particles between the filling of the nano metal particles and the forming of the nano wire grid polarizer.

9. The method of claim 1, wherein in the forming of the nano wire grid polarizer, the nano pattern is removed by an oxygen plasma process or a wet process.
